(19) United States
(12) Patent Application Publication
(10) Pub. No.: US 2025/0392870 A1
(43) Pub. Date: Dec. 25, 2025

(54) SPEAKER DEVICE

(71) Applicants: PIONEER CORPORATION, Bunkyo-ku, Tokyo (JP); Tohoku Pioneer Corporation, Tendo-shi, Yamagata (JP)

(72) Inventors: Hiroaki HOSOYA, Yamagata (JP); Hiroya OIZUMI, Yamagata (JP); Kazuaki WATANABE, Yamagata (JP); Yoshitaka JUNICHO, Yamagata (JP)

(21) Appl. No.: 18/839,182

(22) PCT Filed: Mar. 3, 2022
(86) PCT No.: PCT/JP2022/009108

§ 371 Date: Apr. 9, 2025

(51) Int. Cl. H04R 7/18; H04R 1/02; H04R 7/12; H04R 9/02; H04R 9/04; H04R 9/06

(52) U.S. Cl. CPC H04R 7/18; H04R 1/025; H04R 7/12; H04R 9/025; H04R 9/046; H04R 9/06; H04R 2400/11; H04R 2499/13

(57) ABSTRACT

The present invention provides a speaker device which enables abnormal noises due to contact of a coupler diaphragm with a drive diaphragm to be suppressed and a sound quality to be improved. A speaker device (1) includes: a frame (2); a magnetic circuit (3); a voice coil (42); a voice coil bobbin (41); a drive diaphragm (5) with the voice coil bobbin (41) attached thereto; a first edge (6) coupling an outer peripheral side of the drive diaphragm (5) to the frame (2); a coupler diaphragm (7A) positioned coaxially with the drive diaphragm (5); and a second edge (8A) coupling an outer peripheral side of the coupler diaphragm (7A) to the frame (2). In a view in a direction of a central axis of the drive diaphragm (5), the coupler diaphragm (7A) has a smaller size than the drive diaphragm (5), and the second edge (8A) has a larger projected area than the first edge (6).

### BACKGROUND OF THE INVENTION

### Technical Field

The present invention relates to a speaker device.

### Background Art

There are speaker devices with various structures. As an example, Patent Document 1 discloses a speaker device including a support member, a diaphragm, and a rear cover body, the support member separating an interior space of a vehicle interior room from an exterior space outside the vehicle interior room, wherein the support member has an opening via which the interior space is in communication with the exterior space, wherein the diaphragm is supported by the support member so as to face the opening, wherein the rear cover body is positioned coaxially with the diaphragm and closes the opening.

The rear cover body is formed by a ring-shaped flexible member and a non-flexible diaphragm, wherein the ring-shaped flexible member is made of a highly flexible material such as a soft rubber, and the non-flexible diaphragm is made of a resin and/or metal material. The two members are integrated with each other by using a means such as an adhesive. Such a rear cover body does not only prevent rain water and/or dust from entering the interior space through the opening, but also results in deformation of the rear cover body accompanying vibration of a diaphragm which is part of the speaker. This results in soft braking of vibration of the diaphragm so that the bass sound quality is improved.

### CITATION LIST

### Patent Literature

Patent Document 1: JP 2018-33124 A

### SUMMARY OF THE INVENTION

Conventional speaker devices as mentioned above has the problem that the rear cover body comes into contact with the diaphragm due to rolling, whereby abnormal noise occurs.

As an example, an objective of the present invention is therefore to provide a speaker device which enables abnormal noises due to contact of a coupler diaphragm with a drive diaphragm to be suppressed and a sound quality to be improved.

A speaker device according to the present invention includes: a frame; a magnetic circuit having a magnetic gap; a voice coil disposed in the magnetic gap; a voice coil bobbin with the voice coil wound therearound; a drive diaphragm with the voice coil bobbin attached to an inner peripheral side of the drive diaphragm; a first edge coupling an outer peripheral side of the drive diaphragm to the frame; a coupler diaphragm on a side of the drive diaphragm opposite to the magnetic circuit, the coupler diaphragm being positioned coaxially with the drive diaphragm; and a second edge coupling an outer peripheral side of the coupler diaphragm to the frame, wherein in a view in a direction of a central axis of the drive diaphragm, an outer periphery of the second edge is positioned in a position which is same as or more outward than a position of an outer periphery of the first edge, and wherein in a view in a direction of the central axis of the drive diaphragm, an outer periphery of the coupler diaphragm is positioned in a position which is more inward than a position of an outer periphery of the drive diaphragm.

### BRIEF DESCRIPTION OF THE DRAWINGS

FIG. 1 shows a perspective sectional view of a speaker device according to a first example of the present invention along a plane in which a short axis of a coupler diaphragm extends;

FIG. 2 shows a sectional view of the speaker device according to FIG. 1;

FIG. 3 shows a perspective sectional view of the speaker device according to FIG. 1 along a plane in which a long axis of a coupler diaphragm extends;

FIG. 4 shows a sectional view of the speaker device according to FIG. 3;

FIG. 5 shows a partial sectional view of a second edge according to FIG. 4;

FIG. 6 shows a partial sectional view of a second edge which is part of a speaker device according to a second example of the present invention;

FIG. 7 shows a partial sectional view of a second edge which is part of a speaker device according to a third example of the present invention;

FIG. 8 shows a partial sectional view of a second edge which is part of a speaker device according to a fourth example of the present invention;

FIG. 9 shows a partial sectional view of a second edge which is part of a speaker device according to a fifth example of the present invention;

FIG. 10 shows a coupler diaphragm which is part of a speaker device according to a sixth example of the present invention in a perspective view in (a) and in a side view in (b);

FIG. 11 shows a coupler diaphragm which is part of a speaker device according to a seventh example of the present invention in a perspective view in (a) and in a side view in (b);

FIG. 12 shows a plan view of a coupler diaphragm which is part of a speaker device according to an eighth example of the present invention;

FIG. 13 shows a coupler diaphragm which is part of a speaker device according to a ninth example of the present invention in a perspective view in (a) and in a side view in (b);

FIG. 14 shows a coupler diaphragm which is part of a speaker device according to a tenth example of the present invention in a perspective view in (a) and in a side view in (b);

FIG. 15 shows a plan view of a coupler diaphragm which is part of a speaker device according to an eleventh example of the present invention; and

FIG. 16 shows a coupler diaphragm which is part of a speaker device according to a twelfth example of the present invention in a perspective view in (a) and in a side view in (b).

### DETAILED DESCRIPTION OF THE PREFERRED EMBODIMENTS

Hereinafter, embodiments of the present invention will be described. A speaker device according to an embodiment of the present invention includes: a frame; a magnetic circuit having a magnetic gap; a voice coil disposed in the magnetic gap; a voice coil bobbin with the voice coil wound therearound; a drive diaphragm with the voice coil bobbin attached to an inner peripheral side of the drive diaphragm; a first edge coupling an outer peripheral side of the drive diaphragm to the frame; a coupler diaphragm on a side of the drive diaphragm opposite to the magnetic circuit, the coupler diaphragm being positioned coaxially with the drive diaphragm; and a second edge coupling an outer peripheral side of the coupler diaphragm to the frame, wherein in a view in a direction of a central axis of the drive diaphragm, an outer periphery of the second edge is positioned in a position which is same as or more outward than a position of an outer periphery of the first edge, and wherein in a view in a direction of the central axis of the drive diaphragm, an outer periphery of the coupler diaphragm is positioned in a position which is more inward than a position of an outer periphery of the drive diaphragm. In this manner, the present invention provides that the coupler diaphragm has a smaller size than the drive diaphragm. When vibration of the drive diaphragm is accompanied by vibration of the coupler diaphragm, it is therefore difficult for the coupler diaphragm to come into contact with the drive diaphragm even when rolling of the coupler diaphragm occurs, which enables abnormal noises to be suppressed. Furthermore, the second edge has a larger projected area than the first edge, which can ensure a large vibration region of the coupler diaphragm and thus improve a sound quality.

Preferably, the second edge includes an inner peripheral application surface overlapped with an outer peripheral section of the coupler diaphragm; an outer peripheral application surface overlapped with the frame; and a corrugated section extending from the inner peripheral application surface to the outer peripheral application surface, wherein the corrugated section has one or more crests bent convexly away from the first edge and one or more crests bent convexly toward the first edge which are arranged alternately and continuous with each other, wherein the one or more crests bent convexly away from the first edge have an inverted shape of the one or more crests bent convexly toward the first edge, and wherein the inner peripheral application surface, the outer peripheral application surface, and a boundary between adjacent crests are positioned on a same plane. These features may reduce displacement due to load applied radially, which may make rolling of the coupler diaphragm difficult when vibration of the drive diaphragm is accompanied by vibration of the coupler diaphragm.

Preferably, in the view in the direction of the central axis of the drive diaphragm, the second edge has a larger projected area than the coupler diaphragm. This configuration may ensure a large vibration region of the coupler diaphragm.

Furthermore, the speaker device may be configured to be installed and used in a vehicle, wherein the frame may have an opening via which an exterior space outside a vehicle interior room of the vehicle is in communication with an interior space of the vehicle interior room, wherein the coupler diaphragm may be positioned closer to the exterior space than the drive diaphragm, and wherein the opening may be closed by the coupler diaphragm and the second edge.

Preferably, the drive diaphragm is cone-shaped. When vibration of the drive diaphragm is accompanied by vibration of the coupler diaphragm, the above configuration makes it difficult for the coupler diaphragm to come into contact with the drive diaphragm even when rolling of the coupler diaphragm occurs.

Preferably, the coupler diaphragm has a flat plate shape. When vibration of the drive diaphragm is accompanied by vibration of the coupler diaphragm, the above configuration makes it difficult for the coupler diaphragm to come into contact with the drive diaphragm even when rolling of the coupler diaphragm occurs.

Furthermore, the coupler diaphragm may have a convex or concave portion. This convex or concave portion may enable the coupler diaphragm to be reinforced and make deformation of the coupler diaphragm difficult.

Moreover, in the view in the direction of the central axis of the drive diaphragm, the drive diaphragm and the coupler diaphragm may have a rounded rectangular shape or may have a perfect circular shape.

### EXAMPLES

### First Example

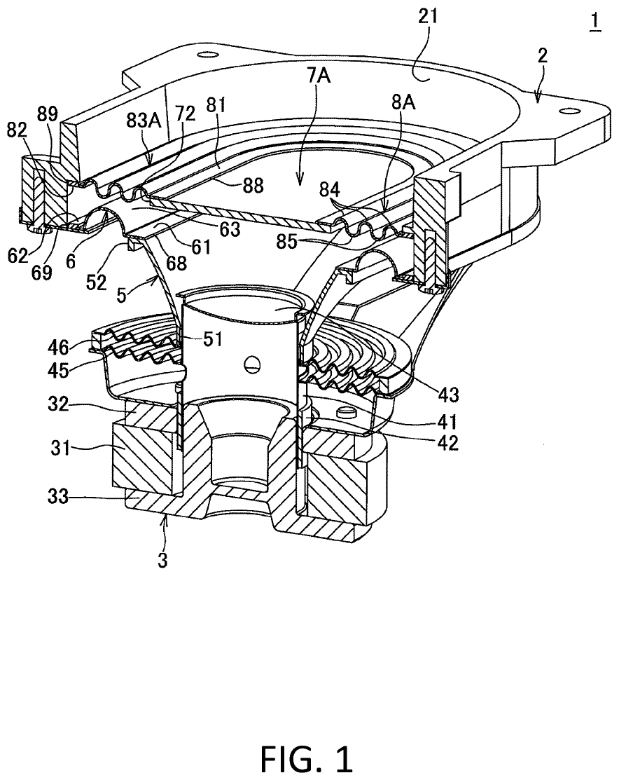

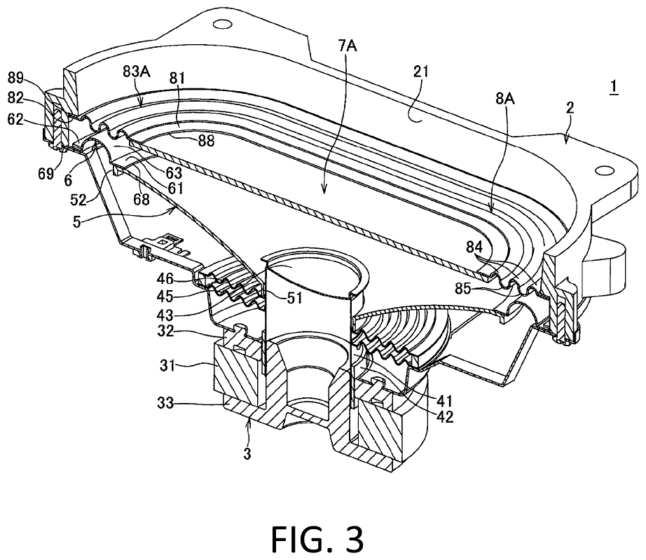

FIGS. 1 to 4 show a speaker device 1 according to a first example of the present invention. This speaker device 1 is installed and used in a vehicle. The speaker device 1 includes a frame 2, a magnetic circuit 3 supported by the frame 2, a voice coil 42 disposed in a magnetic gap of the magnetic circuit 3, a cylindrical voice coil bobbin 41 with the voice coil 42 wound therearound, a drive diaphragm 5 with the voice coil bobbin 41 attached to an inner peripheral section 51 of the drive diaphragm 5, a first edge 6 coupling an outer peripheral side of the drive diaphragm 5 to the frame 2, a center cap 43 covering an opening in the voice coil bobbin 41 facing the drive diaphragm 5, dampers 45 and 46 with inner peripheral sections attached to the voice coil bobbin 41 and outer peripheral sections attached to the frame 2, a coupler diaphragm 7A on a side of the drive diaphragm 5 opposite to the magnetic circuit 3, the coupler diaphragm 7A being positioned coaxially with the drive diaphragm 5, and a second edge 8A coupling an outer peripheral side of the coupler diaphragm 7A to the frame 2.

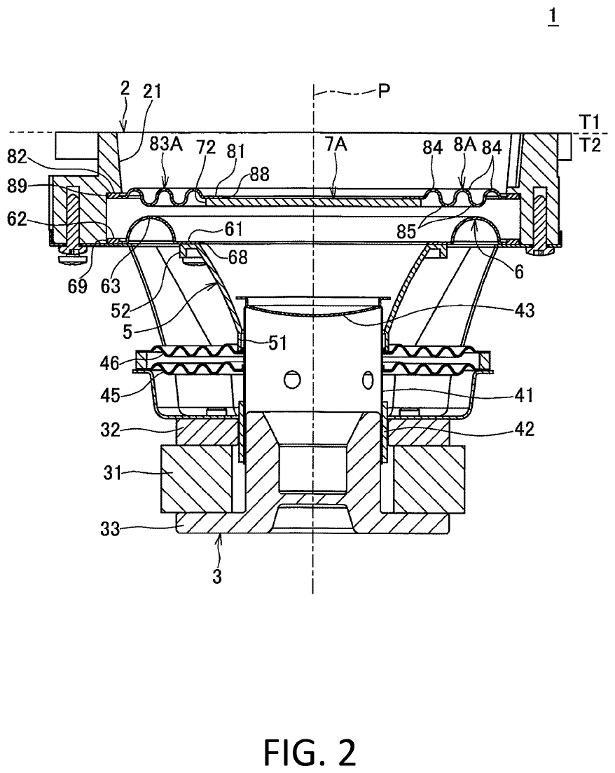

The frame 2 has an opening 21 via which an interior space of the vehicle interior room is in communication with an exterior space outside the vehicle interior room. In FIG. 2, the exterior space T1 is located above the opening 21, and the interior space T2 is located below the opening 21. The speaker device 1 is arranged in the interior space T2, and the coupler diaphragm 7A is positioned closer to the exterior space T1 than the drive diaphragm 5. The coupler diaphragm 7A and the second edge 8A close the opening 21 so that the coupler diaphragm 7A and the second edge 8A form a closed space between the drive diaphragm 5 and the first edge 6. Furthermore, the coupler diaphragm 7A and second edge 8A prevent rain water and/or dust from entering the interior space T2 through the opening 21.

The magnetic circuit 3 is configured e.g. as an outer-magnet type magnetic circuit. The magnetic circuit 3 includes a magnet 31, a top plate 32 and a yoke 33. The magnetic circuit 3 cooperates with the voice coil 42 to vibrate the drive diaphragm 5.

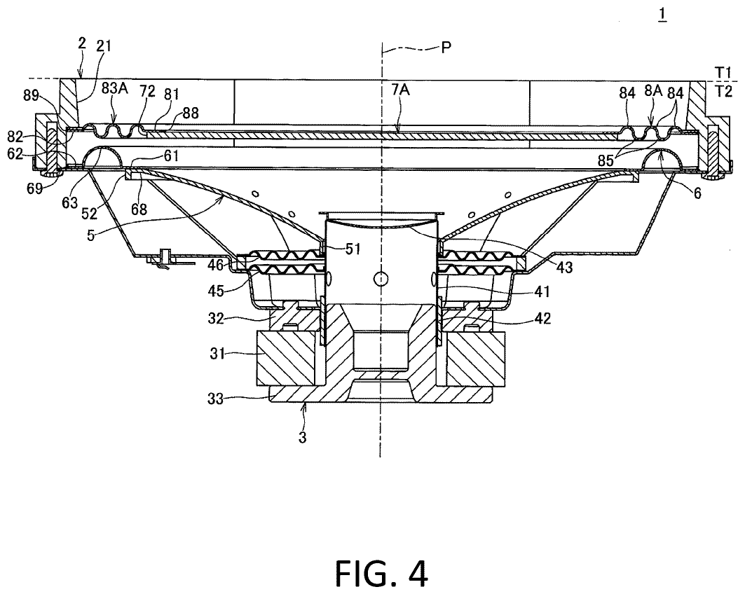

The drive diaphragm 5 is formed in a truncated cone shape (cone-shaped). A dot-dashed line P in FIGS. 2 and 4 indicates a central axis of the drive diaphragm 5. In the present example, the drive diaphragm 5 is formed in a rounded rectangular shape (track shape) in a view in a direction of the central axis. The drive diaphragm 5 is oriented in such a manner that a distance between the drive diaphragm 5 and the coupler diaphragm 7A is reduced in a direction toward an outer periphery 52 from the inner peripheral section 51 of the drive diaphragm 5.

The first edge 6 is made of a soft rubber and formed in a ring shape. The first edge 6 is formed with an inner peripheral application surface 61, an outer peripheral application surface 62, and a flexible portion 63 between the inner peripheral application surface 61 and the outer peripheral application surface 62, wherein the inner peripheral application surface 61 is adhered to an outer peripheral section of the drive diaphragm 5, and the outer peripheral application surface 62 is fixed to the frame 2. In the present example, the flexible portion 63 has a semi-circular cross section which is bulged toward the second edge 8A. However, the flexible portion 63 may also have a semi-circular cross section which is bulged away from the second edge 8A.

In the present example, the coupler diaphragm 7A is formed by using a foam resin, wherein the foam resin is formed in a flat plate shape and covered with a cloth material. The coupler diaphragm 7A according to the present example is further formed in a rounded rectangular shape (track shape) in the view in the direction of the central axis of the drive diaphragm 5. Moreover, an outer periphery 72 of the coupler diaphragm 7A is positioned more inward than the outer periphery 52 of the drive diaphragm 5 in the view in the direction of the central axis of the drive diaphragm 5. In this manner, the coupler diaphragm 7A is formed in a flat plate shape and has a smaller size than the drive diaphragm 5 so that during vibration of the coupler diaphragm 7A accompanying vibration of the drive diaphragm 5, it is difficult for the coupler diaphragm 7A to come into contact with the drive diaphragm 5 even when rolling of the coupler diaphragm 7A occurs, which enables abnormal noises to be suppressed. In addition, the drive diaphragm 5 is also formed in a cone shape which protrudes in a direction away from the coupler diaphragm 7A. During vibration of the coupler diaphragm 7A accompanying the vibration of the drive diaphragm 5, it is thus difficult for the coupler diaphragm 7A to come into contact with the drive diaphragm 5 even when rolling of the coupler diaphragm 7A occurs.

The second edge 8A is made of a soft rubber and formed in a ring shape. The second edge 8A includes an inner peripheral application surface 81, an outer peripheral application surface 82, and a corrugated section 83A extending from the inner peripheral application surface 81 to the outer peripheral application surface 82, wherein the inner peripheral application surface 81 is overlapped with and adhered to an outer peripheral section of the coupler diaphragm 7A, and the outer peripheral application surface 82 is overlapped with and fixed to the frame 2.

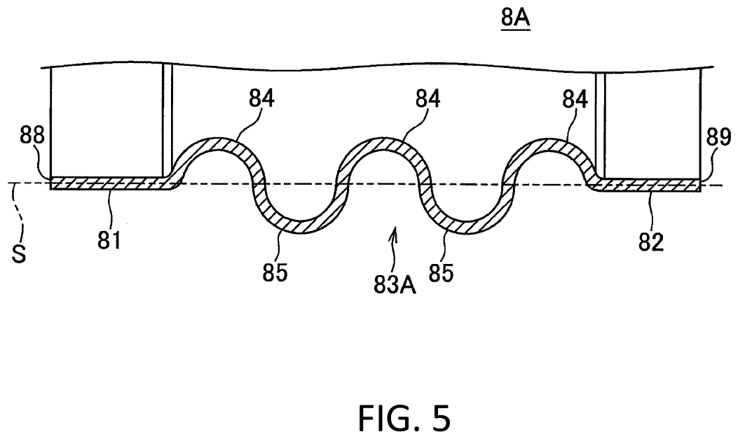

The corrugated section 83A has crests 84 bent convexly away from the first edge 6 and crests 85 bent convexly toward the first edge 6, wherein the crests 84 and crests 85 are arranged alternately and continuous with each other. In the present example, five crests 84 and 85 are provided. As shown in FIG. 5, the crests 84 have an inverted shape of the crests 85. In the present example, the crests 84 and crests 85 have a semi-circular cross section, and have an equal height, equal width and equal curvature.

Furthermore, the second edge 8A is provided such that the inner peripheral application surface 81, the outer peripheral application surface 82, and a boundary between the crests 84 and crests 85 are positioned on a same plane (indicated by a double-dot dash line S in FIG. 5). This feature may reduce displacement due to load applied radially, which may make rolling of the coupler diaphragm 7A difficult when vibration of the drive diaphragm 5 is accompanied by vibration of the coupler diaphragm 7A.

In addition, in the view in the direction of the central axis of the drive diaphragm 5, the outer periphery 89 of the second edge 8A is positioned in a same position as the outer periphery 69 of the first edge 6, and an inner periphery 88 of the second edge 8A is positioned more inward than an inner periphery 68 of the first edge 6. This means that the second edge 8A has a larger projected area than the first edge 6. Furthermore, in the view in the direction of the central axis of the drive diaphragm 5, the second edge 8A has a larger projected area than the coupler diaphragm 7A. This can ensure a large vibration region of the coupler diaphragm 7A and thus improve a sound quality.

Although in the view in the direction of the central axis of the drive diaphragm 5, the outer periphery 89 of the second edge 8A according to the present example is positioned in the same position as the outer periphery 69 of the first edge 6, the outer periphery 89 of the second edge 8A may be positioned more outward than the outer periphery 69 of the first edge 6.

The above-described coupler diaphragm 7A and the second edge 8A form a closed space between the drive diaphragm 5 and the first edge 6, wherein bass sounds are enhanced by vibration of the coupler diaphragm 7A accompanying vibration of the drive diaphragm 5. In the case of using the coupler diaphragm 7A in a speaker device 1, the coupler diaphragm 7A can be vibrated together with vibration of the drive diaphragm 5 as described above, which may enhance bass sounds inside the vehicle interior room as compared with completely sealing the vehicle interior room by means of a vehicle iron sheet.

As described above, the speaker device 1 according to the present example is configured such that a size and/or shape of each of the coupler diaphragm 7A and drive diaphragm 5 is selected so as to suppress contact of the coupler diaphragm 7A with the drive diaphragm 5. In addition, the second edge 8A has a shape which makes rolling of the coupler diaphragm 7A difficult. This enables abnormal noises due to contact of the coupler diaphragm 7A with the drive diaphragm 5 to be suppressed. In addition, the speaker device 1 according to the present example is provided to ensure a large vibration region of the coupler diaphragm 7A while suppressing contact of the coupler diaphragm 7A with the drive diaphragm 5, which enables improvement of the sound quality. Furthermore, the speaker device 1 according to the present example may reduce an acoustic pressure of a sound which leaks out of the vehicle interior room.

### Second Example

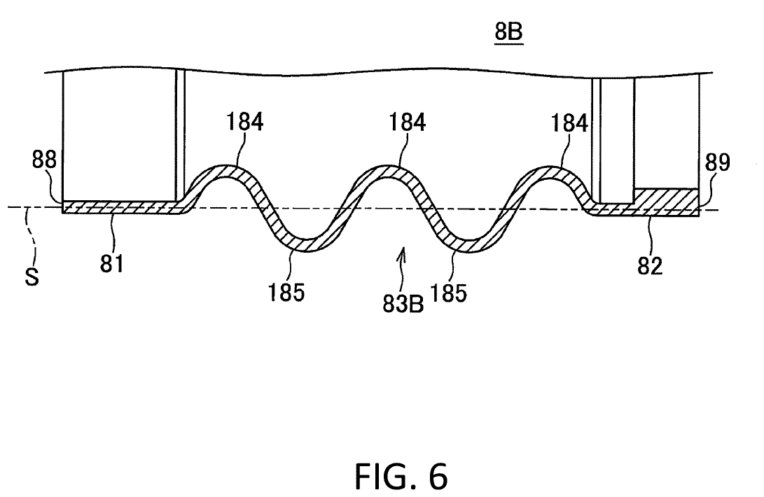

FIG. 6 shows a partial sectional view of a second edge 8B which is part of a speaker device according to a second example of the present invention. In FIG. 6, same elements are designated with same reference signs as those in the first example, wherein description of such elements will be omitted in the following description.

Similarly to the second edge 8A according to the first example, the second edge 8B according to the present example is formed in a ring shape. The second edge 8B includes an inner peripheral application surface 81, an outer peripheral application surface 82, and a corrugated section 83B extending from the inner peripheral application surface 81 to the outer peripheral application surface 82. The corrugated section 83B has crests 184 bent convexly away from the first edge 6 (see FIGS. 1 to 4) and crests 185 bent convexly toward the first edge 6, wherein the crests 184 and crests 185 are arranged alternately and continuous with each other. In the present example, five crests 184 and 185 are provided. The crests 184 have an inverted shape of the crests 185. In the present example, the crests 184 and crests 185 have a V-shaped cross section, and have an equal height and equal width.

Furthermore, the second edge 8B is provided such that an inner peripheral application surface 81, an outer peripheral application surface 82, and a boundary between the crests 184 and crests 185 are positioned on a same plane (indicated by a double-dot dash line S in FIG. 6). This feature may reduce displacement due to load applied radially, which may make rolling of a coupler diaphragm 7A (see FIGS. 1 to 4) difficult when vibration of the drive diaphragm 5 is accompanied by vibration of the coupler diaphragm 7A.

### Third Example

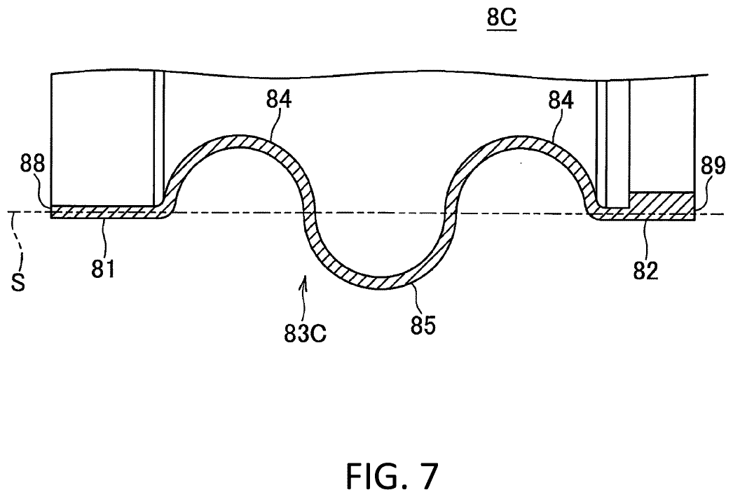

FIG. 7 shows a partial sectional view of a second edge 8C which is part of a speaker device according to a third example of the present invention. In FIG. 7, same elements are designated with same reference signs as those in the first example, wherein description of such elements will be omitted in the following description.

Similarly to the second edge 8A according to the first example, the second edge 8C according to the present example is formed in a ring shape. The second edge 8C includes an inner peripheral application surface 81, an outer peripheral application surface 82, and a corrugated section 83C extending from the inner peripheral application surface 81 to the outer peripheral application surface 82. The corrugated section 83C has crests 84 bent convexly away from the first edge 6 (see FIGS. 1 to 4) and crests 85 bent convexly toward the first edge 6, wherein the crests 84 and crests 85 are arranged alternately and continuous with each other. In the present example, three crests 84 and 85 are provided. The crests 84 have an inverted shape of the crests 85.

Furthermore, the second edge 8C is provided such that an inner peripheral application surface 81, an outer peripheral application surface 82, and a boundary between the crests 84 and crests 85 are positioned on a same plane (indicated by a double-dot dash line S in FIG. 7). This feature may reduce displacement due to load applied radially, which may make rolling of a coupler diaphragm 7A (see FIGS. 1 to 4) difficult when vibration of the drive diaphragm 5 is accompanied by vibration of the coupler diaphragm 7A.

### Fourth Example

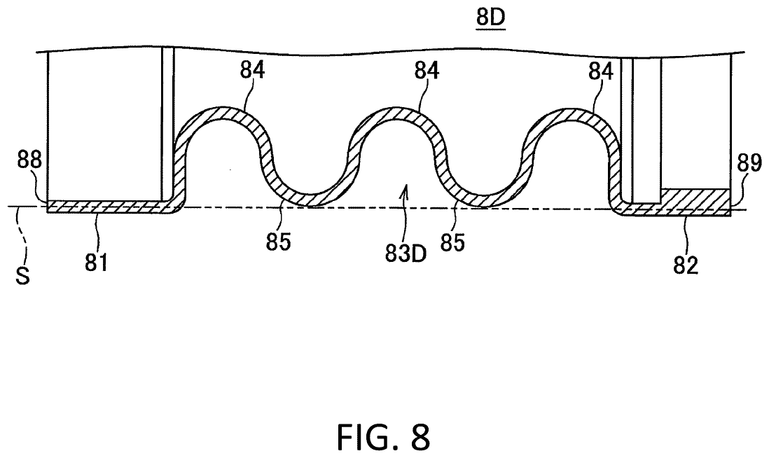

FIG. 8 shows a partial sectional view of a second edge 8D which is part of a speaker device according to a fourth example of the present invention. In FIG. 8, same elements are designated with same reference signs as those in the first example, wherein description of such elements will be omitted in the following description.

Similarly to the second edge 8A according to the first example, the second edge 8D according to the present example is formed in a ring shape. The second edge 8D includes an inner peripheral application surface 81, an outer peripheral application surface 82, and a corrugated section 83D extending from the inner peripheral application surface 81 to the outer peripheral application surface 82. The corrugated section 83D has crests 84 bent convexly away from the first edge 6 (see FIGS. 1 to 4) and crests 85 bent convexly toward the first edge 6, wherein the crests 84 and crests 85 are arranged alternately and continuous with each other. In the present example, five crests 84 and 85 are provided. The crests 84 have an inverted shape of the crests 85.

Furthermore, the second edge 8D is provided such that an inner peripheral application surface 81 and an outer peripheral application surface 82 are positioned on a same plane (indicated by a double-dot dash line S in FIG. 8), wherein the crests 84 and 85 are positioned above the inner peripheral application surface 81 and outer peripheral application surface 82 (opposite to the first edge 6). In the second edge 8D with the above-described configuration, a larger displacement due to load applied radially may occur than in the second edge 8A, 8B or 8C. However, the second edge 8D is also included in the present invention.

### Fifth Example

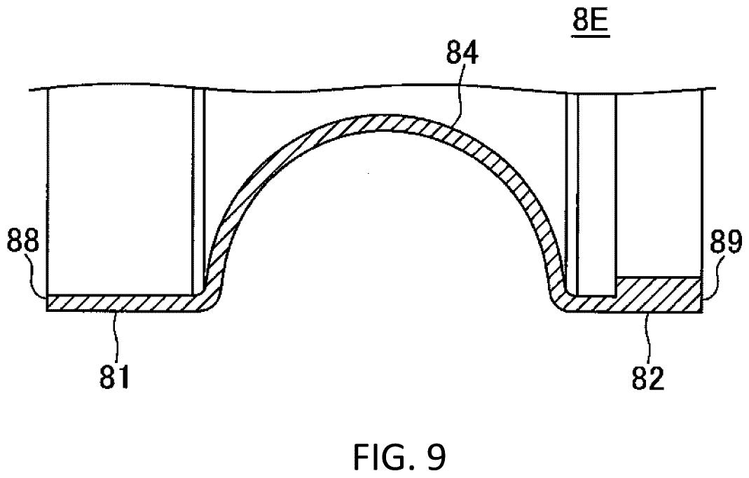

FIG. 9 shows a partial sectional view of a second edge 8E which is part of a speaker device according to a fifth example of the present invention. In FIG. 9, same elements are designated with same reference signs as those in the first example, wherein description of such elements will be omitted in the following description.

Similarly to the second edge 8A according to the first example, the second edge 8E according to the present example is formed in a ring shape. The second edge 8E includes an inner peripheral application surface 81, an outer peripheral application surface 82, and a flexible portion 84 between the inner peripheral application surface 81 and the outer peripheral application surface 82. The flexible portion 84 has a semi-circular cross section which is bulged away from the first edge 6 (see FIGS. 1 to 4). In the second edge 8E with the above-described configuration, a larger displacement due to load applied radially may occur than in the second edge 8A, 8B or 8C. However, the second edge 8E is also included in the present invention.

### Sixth Example

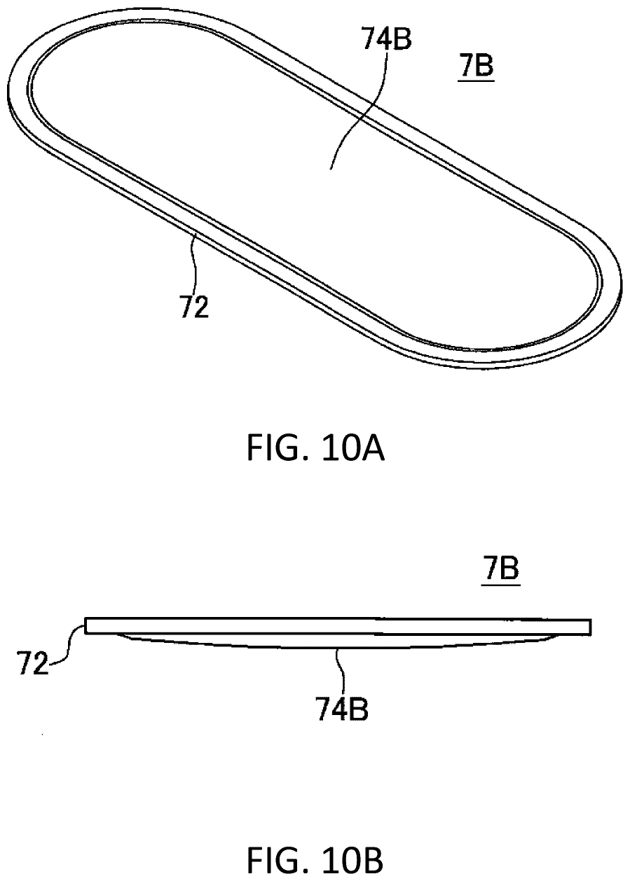

FIG. 10 shows a coupler diaphragm 7B which is part of a speaker device according to a sixth example of the present invention in a perspective view in (a) and in a side view in (b). In FIG. 10, same elements are designated with same reference signs as those in the first example, wherein description of such elements will be omitted in the following description.

While the coupler diaphragm 7A according to the first example has a complete flat-plate shape, the coupler diaphragm 7B according to the present example includes a convex or concave portion 74B formed therein, wherein the convex or concave portion 74B has a rounded rectangular shape (track shape). This convex or concave portion 74B may enable the coupler diaphragm 7B to be reinforced and make deformation of the coupler diaphragm 7B difficult. In the present example, the convex or concave portion 74B is concave on an upper side of the coupler diaphragm 7B (opposite to the drive diaphragm 5) and convex on a lower side of the coupler diaphragm 7B (facing the drive diaphragm 5). However, the convex or concave portion 74B may be positioned with the orientation inversed in a vertical direction.

### Seventh Example

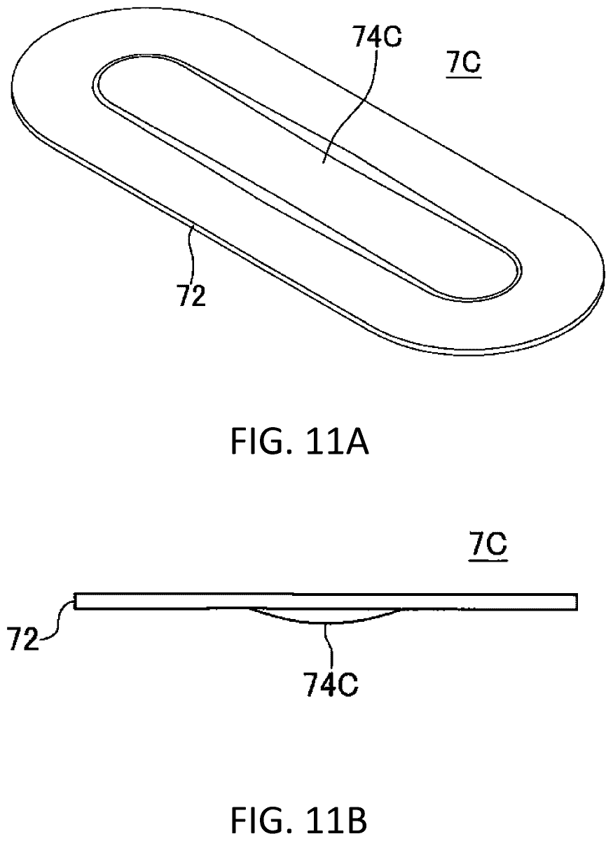

FIG. 11 shows a coupler diaphragm 7C which is part of a speaker device according to a seventh example of the present invention in a perspective view in (a) and in a side view in (b). In FIG. 11, same elements are designated with same reference signs as those in the first example, wherein description of such elements will be omitted in the following description.

The coupler diaphragm 7C according to the present example includes a convex or concave portion 74C formed in a central portion of the coupler diaphragm 7C, wherein the convex or concave portion 74C has a rounded rectangular shape (track shape). The convex or concave portion 74C according to the present example has a smaller size than the above-described convex or concave portion 74B. In this manner, a size of the convex or concave portion according to the present invention is not limited. This convex or concave portion 74C may enable the coupler diaphragm 7C to be reinforced and make deformation of the coupler diaphragm 7C difficult. It is to be noted that the convex or concave portion 74C may be positioned with the orientation inversed in a vertical direction.

### Eighth Example

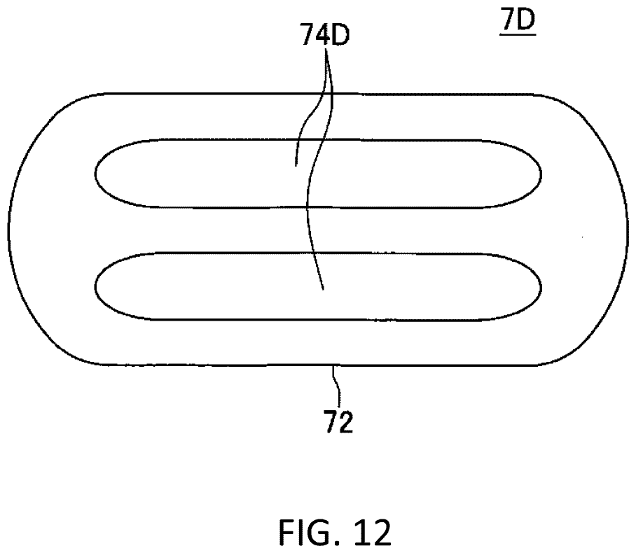

FIG. 12 shows a plan view of a coupler diaphragm 7D which is part of a speaker device according to an eighth example of the present invention. In FIG. 12, same elements are designated with same reference signs as those in the first example, wherein description of such elements will be omitted in the following description.

The coupler diaphragm 7D according to the present example includes two convex or concave portions 74D formed therein, wherein the convex or concave portions 74D have a rounded rectangular shape (track shape). In this manner, the number of the convex or concave portions according to the present invention is not limited. This convex or concave portions 74D may enable the coupler diaphragm 7D to be reinforced and make deformation of the coupler diaphragm 7D difficult.

### Ninth Example

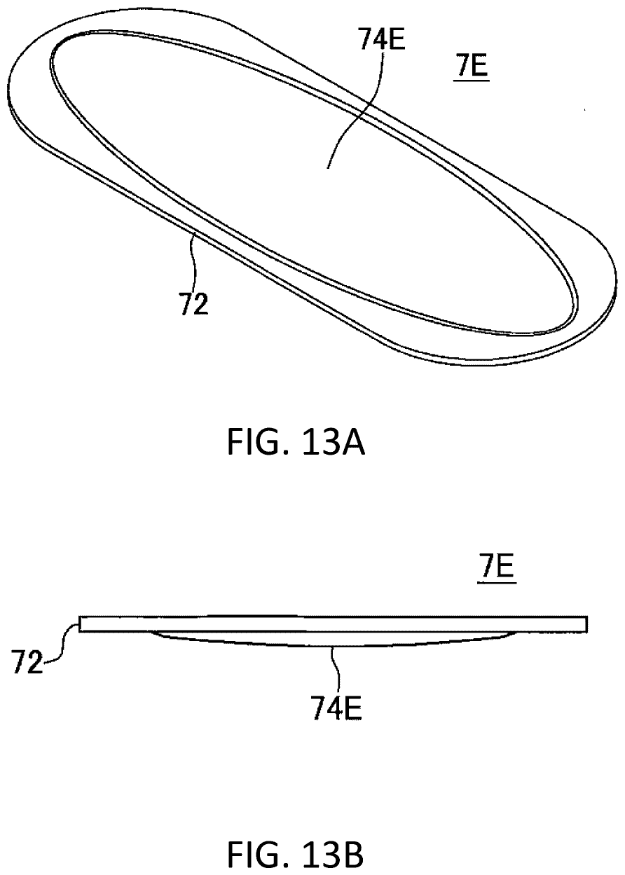

FIG. 13 shows a coupler diaphragm 7E which is part of a speaker device according to a ninth example of the present invention in a perspective view in (a) and in a side view in (b). In FIG. 13, same elements are designated with same reference signs as those in the first example, wherein description of such elements will be omitted in the following description.

The coupler diaphragm 7E according to the present example includes a convex or concave portion 74E formed therein, wherein the convex or concave portion 74E has an elliptical shape. This convex or concave portion 74E may enable the coupler diaphragm 7E to be reinforced and make deformation of the coupler diaphragm 7E difficult. In the present example, the convex or concave portion 74E is concave on an upper side of the coupler diaphragm 7E (opposite to the drive diaphragm 5) and convex on a lower side of the coupler diaphragm 7E (facing the drive diaphragm 5). However, the convex or concave portion 74E may be positioned with the orientation inversed in a vertical direction.

### Tenth Example

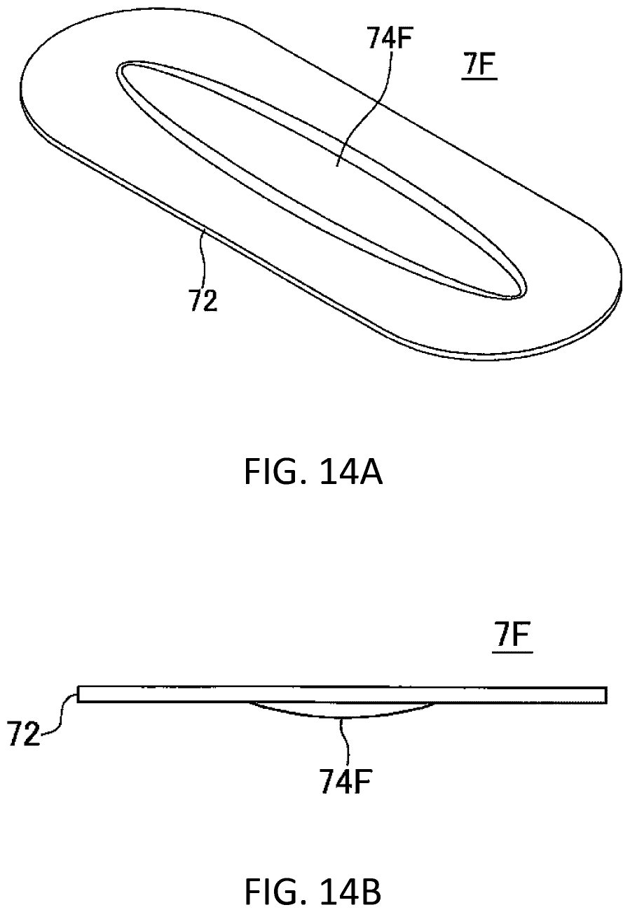

FIG. 14 shows a coupler diaphragm 7F which is part of a speaker device according to a tenth example of the present invention in a perspective view in (a) and in a side view in (b). In FIG. 14, same elements are designated with same reference signs as those in the first example, wherein description of such elements will be omitted in the following description.

The coupler diaphragm 7F according to the present example includes a convex or concave portion 74F formed in a central portion of the coupler diaphragm 7F, wherein the convex or concave portion 74F has an elliptical shape. The convex or concave portion 74F according to the present example has a smaller size than the above-described convex or concave portion 74E. In this manner, a size of the convex or concave portion according to the present invention is not limited. This convex or concave portion 74F may enable the coupler diaphragm 7F to be reinforced and make deformation of the coupler diaphragm 7F difficult. It is to be noted that the convex or concave portion 74F may be positioned with the orientation inversed in a vertical direction.

### Eleventh Example

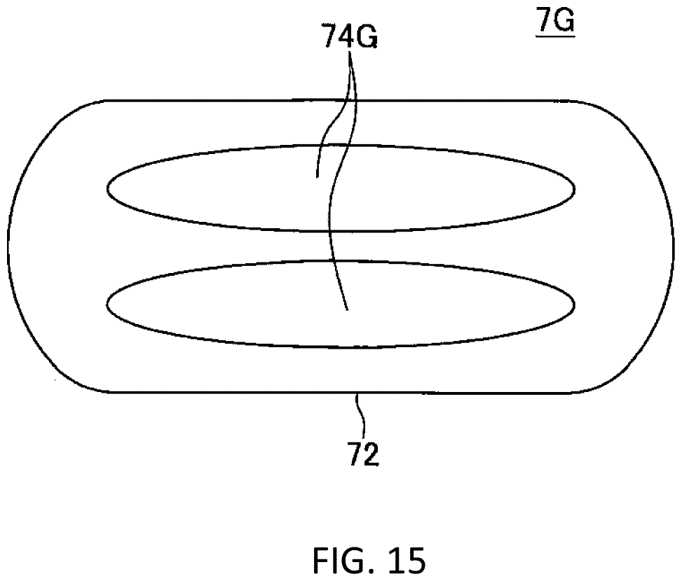

FIG. 15 shows a plan view of a coupler diaphragm 7G which is part of a speaker device according to an eleventh example of the present invention. In FIG. 15, same elements are designated with same reference signs as those in the first example, wherein description of such elements will be omitted in the following description.

The coupler diaphragm 7G according to the present example includes two convex or concave portions 74G formed therein, wherein the convex or concave portions 74G have an elliptical shape. In this manner, the number of the convex or concave portions according to the present invention is not limited. This convex or concave portions 74G may enable the coupler diaphragm 7G to be reinforced and make deformation of the coupler diaphragm 7G difficult.

### Twelfth Example

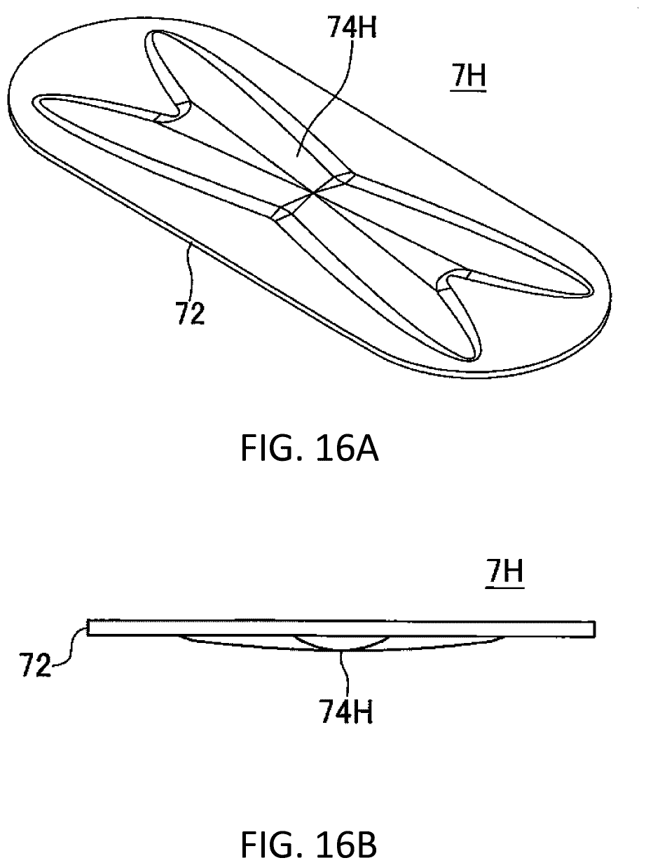

FIG. 16 shows a coupler diaphragm 7H which is part of a speaker device according to a twelfth example of the present invention in a perspective view in (a) and in a side view in (b). In FIG. 16, same elements are designated with same reference signs as those in the first example, wherein description of such elements will be omitted in the following description.

The coupler diaphragm 7H according to the present example includes a convex or concave portion 74H formed therein, wherein the convex or concave portion 74H has an X-shape. This convex or concave portion 74H may enable the coupler diaphragm 7H to be reinforced and make deformation of the coupler diaphragm 7H difficult. In the present example, the convex or concave portion 74H is concave on an upper side of the coupler diaphragm 7H (opposite to the drive diaphragm 5) and convex on a lower side of the coupler diaphragm 7H (facing the drive diaphragm 5). However, the convex or concave portion 74H may be positioned with the orientation inversed in a vertical direction.

While the speaker devices according to the above-described examples are provided such that the drive diaphragm, coupler diaphragm, first edge and second edge are formed in a rounded rectangular shape (track shape) in the view of the direction of the central axis, they may be formed in a perfect circular shape in the view in the direction of the central axis according to the present invention. Also in this case, it is possible to suppress abnormal noises due to contact of the coupler diaphragm with the drive diaphragm and to thus improve the sound quality. It is to be noted that rolling phenomena may occur in particular remarkably along a transverse direction (direction of view on FIG. 2) of the rounded rectangular shape (track shape), and therefore, the present invention is particularly effective for the rolling along the transverse direction of the rounded rectangular shape (track shape).

Although some embodiments of the present invention have been described in details above with reference to the Drawings, specific configurations of the present invention are not limited thereto, but also modifications and/or alterations and the like are included in the present invention, provided that they do not depart from the core of the present invention. Features disclosed in the examples as indicated above with reference to corresponding figures may be combined with each other unless such combinations have any contradiction or issue in their purposes, configurations or the like. Furthermore, each of features as indicated in the figures may constitute an independent embodiment, and other embodiments are possible which include more than one embodiment with a combination of the figures.

### REFERENCE SIGNS LIST

1 Speaker device
2 Frame
3 Magnetic circuit
5 Drive diaphragm
6 First edge
7A, 7B, 7C, 7D, 7E, 7F, 7G, 7H Coupler diaphragm
8A, 8B, 8C, 8D, 8E Second edge
41 Voice coil bobbin
42 Voice coil

What is claimed is:

1. A speaker device comprising:
a frame;
a magnetic circuit having a magnetic gap;
a voice coil disposed in the magnetic gap;
a voice coil bobbin with the voice coil wound therearound;
a drive diaphragm with the voice coil bobbin attached to an inner peripheral side of the drive diaphragm;
a first edge coupling an outer peripheral side of the drive diaphragm to the frame;
a coupler diaphragm on a side of the drive diaphragm opposite to the magnetic circuit, the coupler diaphragm being positioned coaxially with the drive diaphragm; and
a second edge coupling an outer peripheral side of the coupler diaphragm to the frame,
wherein in a view in a direction of a central axis of the drive diaphragm, an outer periphery of the second edge is positioned in a position which is same as or more outward than a position of an outer periphery of the first edge, and
wherein in a view in a direction of the central axis of the drive diaphragm, an outer periphery of the coupler diaphragm is positioned in a position which is more inward than a position of an outer periphery of the drive diaphragm.

2. The speaker device according to claim 1,
wherein the second edge includes:
an inner peripheral application surface overlapped with an outer peripheral section of the coupler diaphragm;
an outer peripheral application surface overlapped with the frame; and
a corrugated section extending from the inner peripheral application surface to the outer peripheral application surface, wherein the corrugated section has one or more crests bent convexly away from the first edge and one or more crests bent convexly toward the first edge which are arranged alternately and continuous with each other,
wherein the one or more crests bent convexly away from the first edge have an inverted shape of the one or more crests bent convexly toward the first edge, and
wherein the inner peripheral application surface, the outer peripheral application surface, and a boundary between adjacent crests are positioned on a same plane.

3. The speaker device according to claim 1 or 2,
wherein in the view in the direction of the central axis of the drive diaphragm, the second edge has a larger projected area than the coupler diaphragm.

4. The speaker device according to any one of claims 1 to 3,
wherein the speaker device is configured to be installed and used in a vehicle,
wherein the frame has an opening via which an exterior space outside a vehicle interior room of the vehicle is in communication with an interior space of the vehicle interior room,
wherein the coupler diaphragm is positioned closer to the exterior space than the drive diaphragm, and
wherein the opening is closed by the coupler diaphragm and the second edge.

5. The speaker device according to any one of claims 1 to 4,
wherein the drive diaphragm is cone-shaped.

6. The speaker device according to any one of claims 1 to 5,
wherein the coupler diaphragm has a flat plate shape.

7. The speaker device according to claim 6,
wherein the coupler diaphragm has a convex or concave portion.

8. The speaker device according to any one of claims 1 to 7,
wherein in the view in the direction of the central axis of the drive diaphragm, the drive diaphragm and the coupler diaphragm have a rounded rectangular shape.
